(19) United States
(12) Patent Application Publication
(10) Pub. No.: US 2026/0029534 A1
(43) Pub. Date: Jan. 29, 2026

(54) POINT CLOUD DATA PROCESSING METHOD, APPARATUS, POINT CLOUD DATA PROCESSING CIRCUIT, AND CHIP

(71) Applicant: SUTENG INNOVATION TECHNOLOGY CO., LTD., Shenzhen (CN)

(72) Inventors: Renfang HUANG, Shenzhen (CN); Yumin LIAO, Shenzhen (CN)

(73) Assignee: SUTENG INNOVATION TECHNOLOGY CO., LTD., Shenzhen (CN)

(21) Appl. No.: 19/277,361

(22) Filed: Jul. 22, 2025

(30) Foreign Application Priority Data
Jul. 25, 2024 (CN) 202411015107.3

(51) Int. Cl. G01S 17/89; G06T 1/60

(52) U.S. Cl. CPC G01S 17/89; G06T 1/60

(57) ABSTRACT

The present application provides a point cloud data processing method, an apparatus, and a point cloud data processing circuit. The point cloud data processing method includes: when processing current point data by an i-th level algorithm, reading current sliding window data centered on the current point data, the current sliding window data including at least two cached data, each cached data being stored in a corresponding cache location, each cached data comprising point data and tag information identifying row number information of the point data, where i is an integer greater than 1; determining target point data based on the tag information, and determining corresponding cached data based on the target point data; and updating the current sliding window data based on the cached data that has been determined, and performing the i-th level algorithm processing on the current sliding window data.

### CROSS-REFERENCE TO RELATED APPLICATION

The present application claims the benefit of priority to Chinese Patent Application No. 202411015107.3, filed on Jul. 25, 2024, which is hereby incorporated by reference in its entirety.

### TECHNICAL FIELD

The present application relates to the technical field of LiDAR, and more specifically, to a point cloud data processing method, apparatus, point cloud data processing circuit, and chip in the technical field of LiDAR.

### BACKGROUND

The main control chip of a LiDAR is the core component responsible for acquisition, processing, and transmission of all LiDAR information. Exemplarily, taking a MEMS galvanometer as an example, its scanning trajectory is spiral. Points in upper spatial positions of a point cloud may be detected later than those in lower positions, and vice versa. When processing point cloud data, the LiDAR main control chip must first perform reordering, making it difficult to ensure data retrieval accuracy during subsequent computational processing.

### SUMMARY

The present application provides a point cloud data processing method, apparatus, point cloud data processing circuit, and chip. The method can ensure computational accuracy of current sliding window data while reducing chip area.

First aspect, a point cloud data processing method is provided. The method includes:

when processing current point data by an i-th level algorithm, reading current sliding window data centered on the current point data, the current sliding window data including at least two cached data, each cached data being stored in a corresponding cache location, each cached data comprising point data and tag information identifying row number information of the point data; wherein i is an integer greater than 1;

determining target point data based on the tag information, and determining corresponding cached data based on the target point data; and

updating the current sliding window data based on the determined cached data, and performing the i-th level algorithm processing on the updated current sliding window data.

Second aspect, a point cloud data processing apparatus is provided. The apparatus includes: a reading module, configured to read current sliding window data centered on current point data when processing the current point data by an i-th level algorithm, the current sliding window data including at least two cached data, each cached data being stored in a corresponding cache location, each cached data comprising point data and tag information identifying row number information of the point data, where i is an integer greater than 1;
a first determination module, configured to determine target point data based on the tag information, and determine corresponding cached data based on the target point data; and
a processing module, configured to update the current sliding window data based on the determined cached data, and perform the i-th level algorithm processing on the updated current sliding window data.

Third aspect, a point cloud data processing circuit is provided. The point cloud data processing circuit is configured to execute the point cloud data processing method according to the foregoing aspects.

Fourth aspect, an SoC chip is provided. The SoC chip is configured with the point cloud data processing circuit according to the foregoing aspects.

Fifth aspect, a computer device is provided. The computer device is configured to execute the point cloud data processing method according to the foregoing aspects.

Sixth aspect, a computer-readable storage medium is provided. The computer-readable storage medium stores computer program code that, when executed on a computer, causes the computer to execute the point cloud data processing method according to the foregoing aspects.

Beneficial effects of the technical solutions provided in embodiments of this application include at least the following:

Embodiments of this application provide a point cloud data processing approach. When performing i-th level algorithm processing on current point data, the method first reads current sliding window data centered on the current point data from a cache space; instead of directly processing the read current sliding window data, identifies whether each cached data in the current sliding window data is target point data; determines target point data required for current sliding window computation based on tag information in the cached data and updates the current sliding window data to obtain accurate current sliding window data for computation; finally performs the i-th level algorithm processing on the updated current sliding window data. This approach ensures accurate determination of current sliding window data based on tag information while reducing chip area, thereby guaranteeing accuracy of sliding window computation and further ensuring accuracy of point cloud data processing.

### BRIEF DESCRIPTION OF DRAWINGS

FIG. 1 is a schematic flowchart of a point cloud data processing method according to an embodiment of this application.

FIG. 2 is a schematic diagram of a point cloud data processing procedure according to an embodiment of this application.

FIG. 3 is a schematic diagram of a multi-level algorithm module according to an embodiment of this application.

FIG. 4 is a schematic diagram of current sliding window data according to an embodiment of this application.

FIG. 5 is a schematic flowchart of another point cloud data processing method according to an embodiment of this application.

FIG. 6 is a schematic flowchart of another point cloud data processing method according to an embodiment of this application.

FIG. 7 is a schematic diagram of a process for writing back cached data according to an embodiment of this application.

FIG. 8 is a schematic diagram of another process for writing back cached data according to an embodiment of this application.

FIG. 9 is a schematic diagram of a target point data determination process according to an embodiment of this application.

FIG. 10 is a schematic flowchart of another point cloud data processing method according to an embodiment of this application.

FIG. 11 is a schematic diagram of another target point data determination process according to an embodiment of this application.

FIG. 12 is a structural schematic diagram of a point cloud data processing apparatus according to an embodiment of this application.

FIG. 13 is a structural schematic diagram of an SoC chip according to an embodiment of this application.

### DETAILED DESCRIPTION

The technical solutions in the embodiments of this application will be described below with reference to the accompanying drawings. In the description of the embodiments of this application, unless otherwise specified: “/” denotes “or”. For example, A/B may represent A or B. “and/or” describes an association relationship, indicating that three relationships may exist. For example, A and/or B may represent: A alone, both A and B, or B alone. In present application, “a plurality” means two or more.

The terms “first” and “second” are used for descriptive purposes only and should not be construed as implying relative importance or implicitly indicating the quantity of technical features. Features defined by “first” or “second” may explicitly or implicitly include one or more such features.

The execution entity of the point cloud data processing method provided in the embodiments of this application may be:
a LiDAR, specifically a point cloud data processing circuit inside the LiDAR or an SoC chip inside the LiDAR; or a computer device communicatively connected to the LiDAR, such as a tablet, a radar auxiliary computer, a vehicle terminal, or a mobile terminal.

The following uses the point cloud data processing circuit as the execution entity for description.

In LiDAR application scenarios, point cloud data is obtained after a LiDAR (or a LiDAR device) scans a field of view and is subsequently processed to recognize and analyze target objects within that field of view. The scanning trajectory across the field of view is determined by the scanning method adopted by the scanning device of the LiDAR. Under certain scanning methods, such as the spiral scanning method used by MEMS galvanometers, row-direction shifting (upward or downward) occurs in point cloud images. This results in a phenomenon in which points located at upper spatial positions in the image may have later detection times than points located at lower spatial positions. Conversely, points at lower spatial positions in the image may have earlier detection times than points at upper spatial positions.

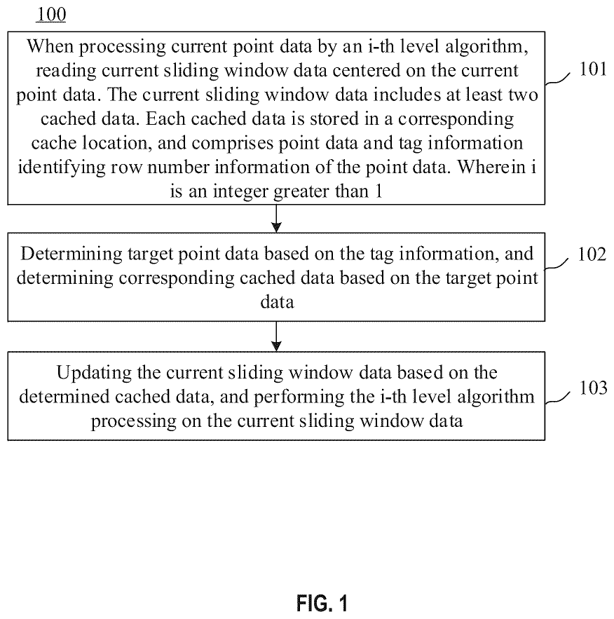

FIG. 1 is a schematic flowchart of a point cloud data processing method according to an embodiment of this application. Exemplarily, as shown in FIG. 1, method 100 includes:

Step 101: When processing current point data by an i-th level algorithm, reading current sliding window data centered on the current point data. The current sliding window data includes at least two cached data. Each cached data is stored in a corresponding cache location, and includes point data and tag information identifying row number information of the point data. I is an integer greater than 1.

Due to the aforementioned point cloud image shifting phenomenon, an Image Signal Processing (ISP) module needs to perform reordering processing on the point cloud data during processing. If a computational submodule in the ISP module processes based on sorted point cloud sliding windows, the result of the current sliding window computation may update points at column coordinate positions in rows above the current row, or update points at column coordinate positions in rows below the current row.

When acquiring “source data” for the sliding window, two situations exist: when no sliding window computation modifies point cloud values below the center point coordinate, the source data value required for downward sliding windows always remains the value output by the previous-level algorithm; when sliding window computation modifies point cloud values below the center point coordinate, the data acquired during downward sliding must retain modifications made by the current-level algorithm to corresponding points within the sliding window during the current frame's history.

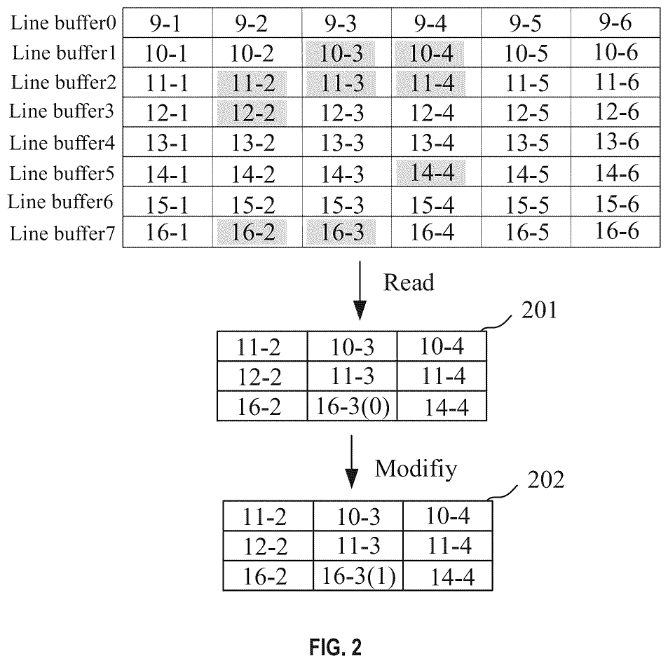

Exemplarily, referring to FIG. 2, assume the buffer space in the algorithm B computational submodule of the ISP module is 8 rows with initial value 0. During operation of the algorithm B computational submodule, when the sliding window center point slides to 11_3 (represented by the center point coordinate position, i.e., sliding window 11_3), sorted sliding window data 201 is acquired, including (11-2, 10-3, 10-4, 12-2, 11-3, 11-4, 16-2, 16-3, 14-4). During computation, the data for 16-3 is modified (16-3(0) in 101 is modified to 16-3(1) in 202). Since the buffer space buf_line7 storing 16_3 point cloud information is cyclically reused (i.e., point cloud data for row 8, row 16, row 24, etc., are all saved in this storage space), subsequently acquired 16_3 point cloud data cannot distinguish whether it belongs to row 8's 8_3 data or data modified after sliding window 11_3 computation.

During the processing of one frame of point cloud data, multiple modifications may occur. To retain these modification values so they can be read during downward sliding and to distinguish whether they are required for downward sliding processing, one approach is to cache an entire frame of point cloud data within the algorithm B computational submodule. This prevents multiple points within the frame of the point clouds from reusing the same address space for caching, thereby avoiding the problem of being unable to distinguish whether the data is required for the current sliding window. Although caching an entire frame of point cloud data avoids the aforementioned problem, it undoubtedly increases chip area and processing power consumption.

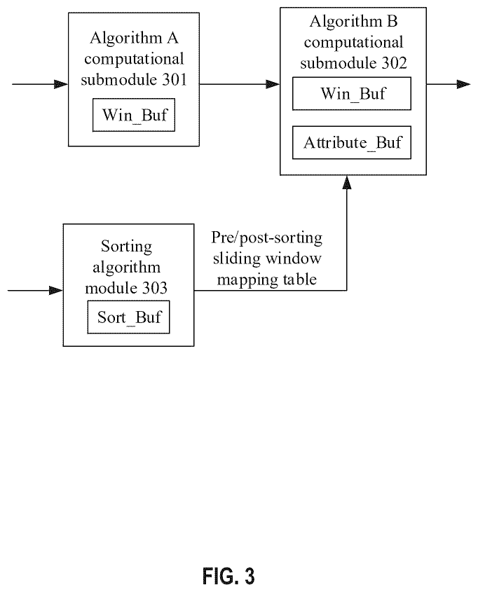

Exemplarily, referring to FIG. 3, which is a schematic diagram of a multi-level algorithm module. Taking a multi-level algorithm module including an algorithm A computational submodule 301 and an algorithm B computational submodule 302 as an example: the algorithm A computational submodule 301 involves sliding window processing of pre-sorted point cloud data, the algorithm B computational submodule 302 involves sliding window processing of both pre-sorted point cloud data and post-sorted point cloud data.

Attribute_Buf in algorithm B computational submodule 302 is the cache space for computation results of the attribute field. Win_Buf in algorithm A submodule 301 and algorithm B computational submodule 302 is the buffer for sliding window data before sorting, serving as the buffer for caching source data to be computed. In the multi-level algorithm processing shown in FIG. 3, for the algorithm B submodule, when performing sliding window processing on post-sorted point cloud data, it needs to read sliding window data from the pre-sorted point cloud data stored in Win_Buf based on the pre/post-sorting sliding window mapping table output by the sorting algorithm module 303, in order to perform algorithm B processing. However, Win_Buf has a limited number of cache rows, leading to cyclic reuse. Furthermore, sliding window processing may involve modifying point cloud data, and the modified point cloud data continues to be stored in Win_Buf. These factors may cause subsequently acquired point cloud data from Win_Buf during sliding window processing to potentially be the data required for sliding window processing or not the data required. To solve this problem, related art may increase the number of cache rows in Win_Buf for algorithm B, for example, increasing it to cache an entire frame of raw point cloud data, to avoid issues caused by cyclic reuse of cache space. However, increasing the cache row count to cache an entire frame of raw point cloud data obviously significantly increases the chip area and power consumption of the multi-level algorithm processing chip.

To address the challenge of balancing chip cost with the processing accuracy of multi-level algorithms, this embodiment optimizes the sliding window processing flow within the algorithm B computational submodule. This optimization enables the algorithm B computational submodule to properly process post-sorted point cloud data while minimizing the required number of cache rows.

In one implementation, when the i-th level algorithm is used to process current point data, the method first reads sliding window data centered on the current point data. The current sliding window data includes at least two cached data entries, with each cached data entry stored at a corresponding cache location. Each cached data entry contains both the point data and tag information that identifies the row number of the respective point data.

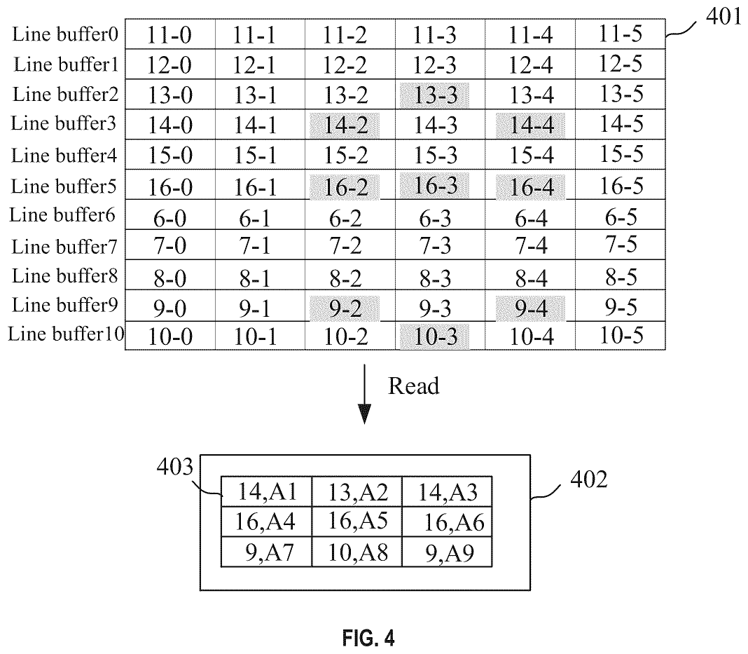

Exemplarily, the i-th level algorithm can be the algorithm B computational submodule shown in FIG. 3, and correspondingly, the current sliding window data centered on the current point data is read from the Win_Buf of algorithm B. The number of cached data included in the current sliding window data can be determined by the sliding window specification. If the window specification is 9, the current sliding window data includes 9 cached data. As shown in FIG. 4, when reading current sliding window data centered on current point data 16-3, cached data adjacent in position after sorting are not necessarily adjacent before sorting. Based on the pre/post-sorting sliding window mapping table, determine the pre-sorting positions of the cached data to be read from the cache region 401. Read the current sliding window data from the buffer according to the pre-sorting positions, resulting in cached data: (14, A1), (13, A2), (14, A3), (16, A4), (16, A5), (16, A6), (9, A7), (10, A8), (9, A9). Taking cached data 1 (403) as an example, cached data 1 includes tag information 14 identifying the row number and point data A1.

Step 102: Determining target point data based on the tag information, and determining corresponding cached data based on the target point data.

For any point, the difference of row coordinates between its position before and after sorting does not exceed a preset number of rows. Therefore, with tag information included in the cached data, the target point data required for current sliding window data processing can be determined based on the tag information. The corresponding cached data is then determined for subsequent i-th level algorithm processing, based on the target point data.

Specifically, if the tag information indicates that the point data in the cached data is not the point data required for the current sliding window data, it is necessary to read the cached data corresponding to the required pre-sorting row number for the current sliding window data as the target point data. If the tag information indicates that the point data in the cached data is the point data required for the current sliding window data, the point data in the read cached data is determined as the target point data.

Step 103: Updating the current sliding window data based on the determined cached data, and performing the i-th level algorithm processing on the current sliding window data.

After determining the cached data, the current sliding window data can be updated accordingly, and the i-th level algorithm processing is performed on the current sliding window data.

In summary, this embodiment provides a point cloud data processing method. When performing i-th level algorithm processing on current point data, the method first reads current sliding window data centered on the current point data from a cache space. However, it does not directly process the read current sliding window data, instead, it identifies whether each cached data in the current sliding window data is target point data. The method then determines the target point data required for current sliding window computation based on the tag information in the cached data and updates the current sliding window data to obtain accurate current sliding window data for computation. Finally, it performs i-th level algorithm processing on the updated current sliding window data.

This approach ensures the accurate determination of current sliding window data based on tag information while reducing chip area, thereby guaranteeing accuracy of sliding window computation and further ensuring accuracy of point cloud data processing.

When determining target point data based on the tag information, the tag information is used to judge whether the point data in the cached data is the target point data required for processing the current point data. Different judgment results correspond to different methods for determining the target point data.

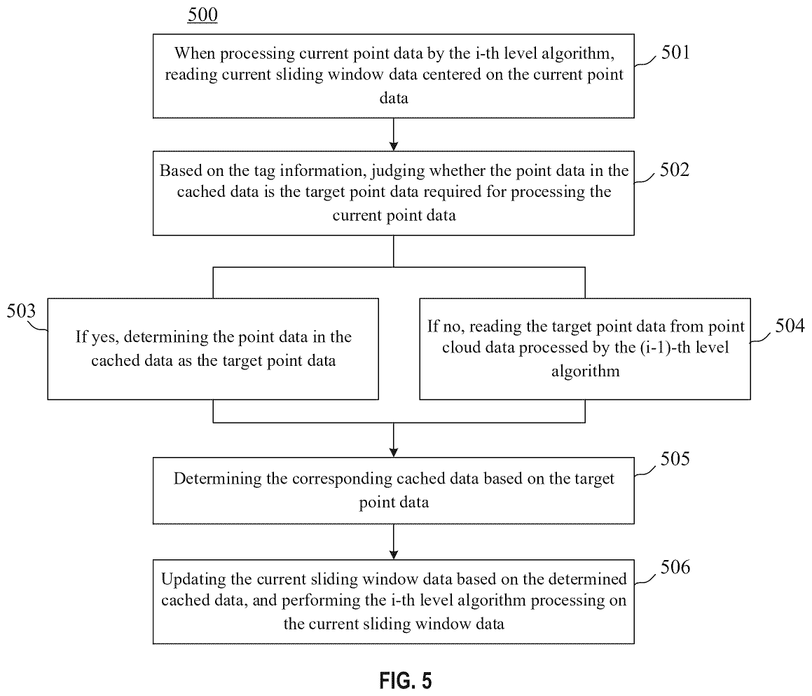

FIG. 5 is a schematic flowchart of another point cloud data processing method according to an embodiment of this application. Exemplarily, as shown in FIG. 5, method 500 includes:

Step 501: When processing current point data by the i-th level algorithm, reading current sliding window data centered on the current point data.

The implementation of Step 501 can refer to Step 101. Details are not repeated here.

Step 502: Based on the tag information, judging whether the point data in the cached data is the target point data required for processing the current point data.

For any cached data in the current sliding window data, the tag information in the cached data is sued to judge whether the point data in that cached data is the target point data required for processing the current point data.

Step 503: If yes, determining the point data in the cached data as the target point data.

For cases where the point data in the cached data is the required target point data, the point data in the cached data is determined as the target point data for subsequent participation in current sliding window data computation.

Step 504: If no, reading the target point data from point cloud data processed by the (i−1)-th level algorithm.

For cases where the point data in the cached data is not the target point data, the required target point data can be re-read from the point cloud data processed by the previous-level algorithm. Specifically, the target point data can be read from the point cloud data processed by the (i−1)-th level algorithm according to the target row number of the point data required for current sliding window data processing.

Exemplarily, for multi-level algorithm modules, computation results from preceding-level algorithm modules can be passed to subsequent-level algorithms. If the i-th level algorithm is the first-level algorithm in the multi-level algorithm module, the target point data can be read from the original point cloud data according to the target row number of the point data required for the current sliding window data processing.

Step 505: Determining the corresponding cached data based on the target point data.

Step 506: Updating the current sliding window data based on the determined cached data, and perform the i-th level algorithm processing on the current sliding window data.

After determining the target point data required for processing the current point data, the cached data corresponding to this target point data can be determined, and the current sliding window data is updated based on the determined cached data. For positions where the read point data in the cached data is not the target point data, updating the current sliding window data with the target point data read from the (i−1)-th level output point cloud data. For positions where the read point data in the cached data is the target point data, retaining the cached data. After all cached data in the current sliding window data are updated, the updated current sliding window data is obtained, and the i-th level algorithm processing is performed on the updated current sliding window data.

This embodiment provides a point cloud data processing method leveraging sorting features. Specifically, combining the sorting feature, for example, the difference of row coordinates before and after sorting for any point does not exceed a preset number of rows. By utilizing the tag information identifying row number information of the point data within the cached data when reusing cache space, it can determine whether the point data in the cached data is the point data required for current sliding window computation. This embodiment judges whether the point data in the cached data is the target point data required for the current sliding window data via the tag information, and provides two methods for determining the target point data based on the judgment result, which ensures that, regardless of whether the read point data in the cached data is the target point data, the required target point data for the current sliding window data can be acquired through the corresponding determination method, thereby guaranteeing the smooth progress of sliding window computation.

Regarding the method of determining whether point data in the cached data is the target point data based on tag information, there are primarily two approaches:
Judgment Method 1: Judge based on the row number information of the center point data and the tag information in the cached data.
Judgment Method 2: Judge based on the row number information of the point data required for the current sliding window data and the tag information in the read cached data.

When performing i-th level algorithm processing on historical sliding window data, the processing result of the i-th level algorithm may modify the point data in one or more cached data within the historical sliding window data, especially cached data below the center position of the historical sliding window. The modified point data and the tag information are then re-stored in a specific cache location within the cache region. During subsequent sliding window processing, if cached data from this cache location needs to be read, the method used to judge whether this cached data is the target point data required for the current point data is determined by how the tag information for the modified point data was defined. That is, the two judgment methods and the methods for determining the tag information have a one-to-one correspondence. Correspondingly, the following sections describe these two judgment methods and their associated tag determination methods using two specific embodiments.

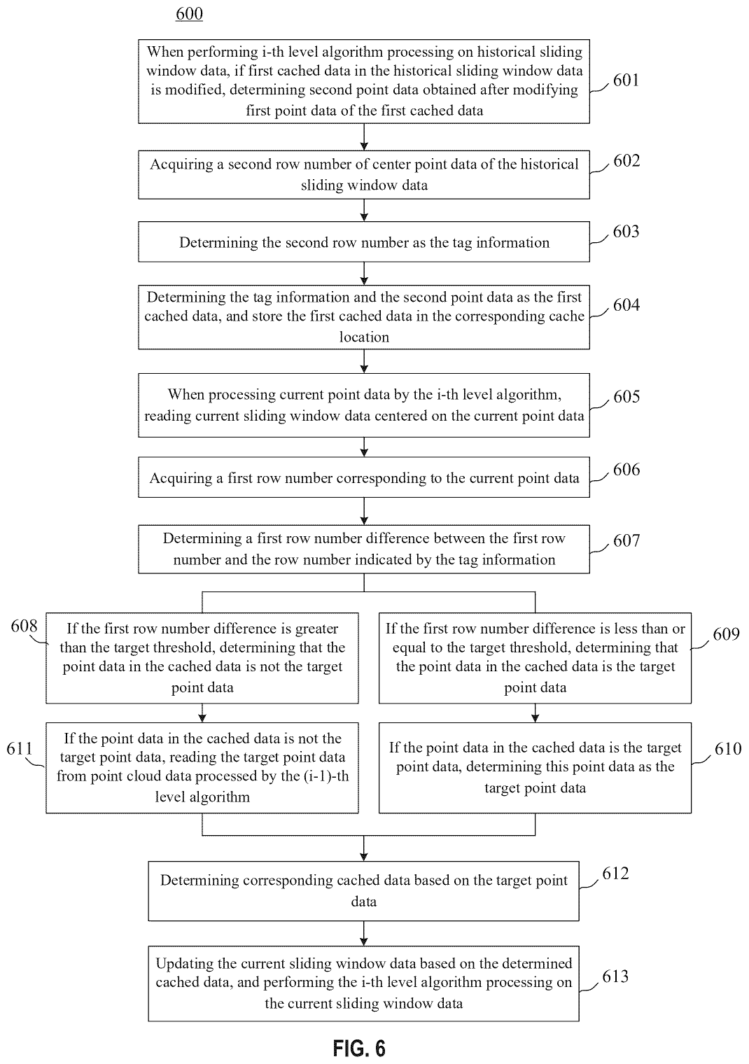

FIG. 6 is a schematic flowchart of another point cloud data processing method according to an embodiment of this application. As shown in FIG. 6, method 600 includes:

Step 601: When performing i-th level algorithm processing on historical sliding window data, if first cached data in the historical sliding window data is modified, determining second point data obtained after modifying first point data of the first cached data.

When performing i-th level algorithm processing on historical sliding window data, if the first cached data in the historical sliding window data is modified, the modified point data needs to be written back to the corresponding cache location in the cache region so that the modified point data can be used in subsequent sliding window processing. Considering that each cache location stores cached data composed of point data and tag information, when caching the modified point data to the cache location, both the point data to be cached and its tag information need to be obtained. In one implementation, when performing i-th level algorithm processing on historical sliding window data, if the first cached data in the historical sliding window data is modified, the method first determines the second point data obtained after modifying the first point data of the first cached data, and then determines the tag information used to mark the row number corresponding to the second point data.

Step 602: Acquiring a second row number of center point data of the historical sliding window data.

Step 603: Determining the second row number as the tag information.

Two primary methods are provided for determining the tag information identifying the row number corresponding to the modified second point data:
Method 1: Use the row number of the sliding window's center point to mark the modified point data being written back.
Method 2: Use the row number of the modified point to mark the modified point data being written back.

If Method 1 is used to mark the modified point data being written back, for the historical sliding window data, it is necessary to acquire the second row number of the center point data of the historical sliding window data, so as to determine the second row number as the tag information marking the point data modified during i-th level algorithm processing.

Step 604: Determining the tag information and the second point data as the first cached data, and store the first cached data in the corresponding cache location.

Correspondingly, the tag information (second row number) and the second point data are concatenated to form the first cached data, and the first cached data is stored in the corresponding cache location.

To ensure the cyclically used buffer can store all point data within the sliding window data, the buffer depth needs to be 2N+1, where N is the target threshold. That is, the cache row count of the cache region must be at least 2N+1 rows. In other words, in this embodiment, the cache row count of the cache region corresponding to the i-th level algorithm is less than the row count of one frame of point cloud data, and the cache row count of the cache region is greater than twice the target threshold. Exemplarily, when N (the target threshold) is 5, the minimum cache row count of the cache region is 11.

When writing back the first cached data to the cache location, the specific cache location in the cache region must also be determined. In one implementation, when writing back the first cached data, the cache location from which the first cached data was originally read can be acquired, and the modified first cached data can be written back to that cache location. That is, whichever cache location in the cache region the first cached data was read from when acquiring the historical sliding window data, the modified first cached data is written back to that cache location.

In some embodiments, a method for determining the write-back cache location based on row number information is provided. Correspondingly, in an exemplary example, storing the first cached data in the corresponding cache location in Step 604 may further include Steps 604A to 604C.

Step 604A: Acquiring a first cache row number of the center point data of the historical sliding window data in the cache region, a target column number of the first point data, and a second row number difference between the row number of the first point data and the row number of the center point data.

Given the cache row number of the center point data of the historical sliding window data in the cache region and the row number difference between the row number of the first point data and the row number of the center point data, the cache row number of the cache location for the first cached data in the cache region can be determined based on this cache row number and row number difference. The cache column number is determined by the target column number of the first point data. Therefore, when writing back the first cached data, by acquiring the first cache row number of the center point data of the historical sliding window data in the cache region, the target column number of the first point data, and the second row number difference between the row number of the first point data and the row number of the center point data, the cache location for the first cached data in the cache region can be determined based on the first cache row number, the second row number difference, and the target column number.

It should be noted that the “row number” and “column number (or target column number)” provided in this embodiment refer to the row and column numbers of the point data within the point cloud data, while the “cache row number” and “cache column number” refer to the row and column numbers of the cache location where the point data is cached in the cache location of cache region.

Step 604B: Based on the first cache row number and the second row number difference, determining a second cache row number of the cache location for the first point data in the cache region.

Given the cache row number of the center point data of the historical sliding window data in the cache region and the row number difference between the row number of the first point data and the row number of the center point data, the second cache row number of the cache location for the first point data in the cache region can be determined based on the first cache row number and the second row number difference.

Exemplary, if the first cache row number is 5 and the second row number difference is 2, then the second cache row number is 5+2=7.

Step 604C: Based on the relationship between the second cache row number and the maximum cache row number of the cache region, storing the first cached data in the corresponding cache location.

The cache region includes M*K cache locations (i.e., M rows and K columns). Each cache location has its own cache row number and cache column number. The maximum cache row number in the cache region is determined by the initial cache row number set in the cache region and the cache row count (M) of the cache region. Exemplarily, if the cache row count M of the cache region is 11 and the set initial cache row number is 0, the maximum cache row number is 10. If the set initial cache row number is 1, the maximum cache row number is 11. If the set initial cache row number is 10, the maximum cache row number is 20. The cache row number is used to identify different rows within the cache region.

Considering the limited cache row count of the cache region (e.g., if the cache row count is 11, the cache row numbers are 0-10, and the maximum cache row number is 10), the determined second cache row number may be greater than 10. In this case, writing back the cached data directly based on the second cache row number would obviously result in write-back errors. Therefore, after determining the second cache row number, it is necessary to determine how to store the first cached data to the accurate cache location based on the relationship between the second cache row number and the maximum cache row number of the cache region.

Specifically, if the determined second cache row number is less than or equal to the maximum cache row number, it indicates no overflow, and the first cached data can be cached directly based on the second cache row number and target column number. That is, the modified first cached data is stored in the cache location corresponding to the second cache row number and target column number.

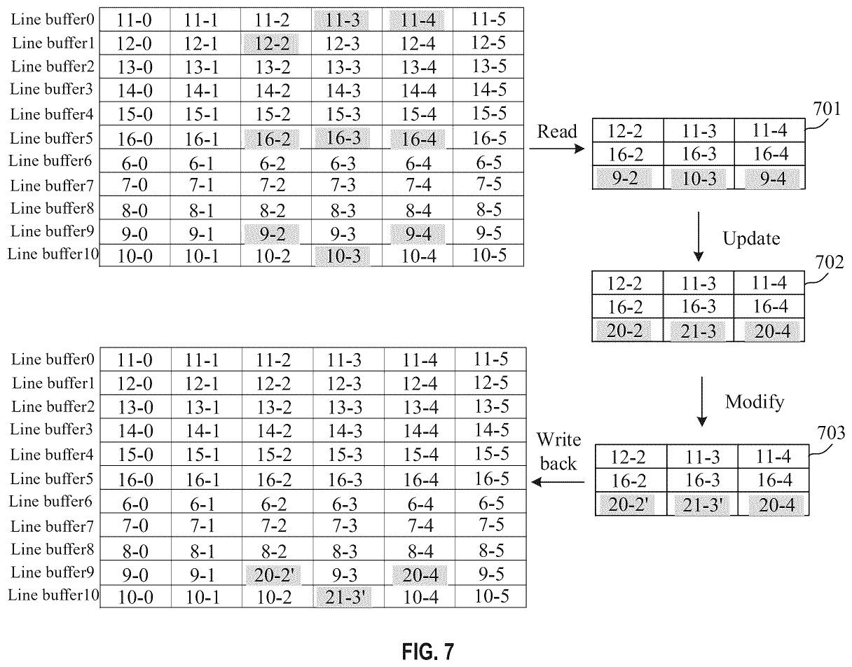

FIG. 7 is a schematic diagram of a process for writing back cached data according to an embodiment of this application. As shown in FIG. 7, taking historical sliding window data 701 (12-2, 11-3, 11-4, 16-2, 16-4, 9-2, 10-3, 9-4) read with 16-3 as the center point data as an example, the method uses tag information to judge whether the cached data in historical sliding window data 701 is the target point data required for sliding window computation, thereby obtaining updated historical sliding window data 702 (12-2, 11-3, 11-4, 16-2, 16-4, 20-2, 21-3, 20-4). The i-th level algorithm processing is then performed on the updated historical sliding window data 702, modifying the cached data for 20-2 and 21-3 during processing (e.g., 20-2′ and 21-3′ in modified historical sliding window data 703). The modified cached data needs to be written back to the cache region.

Taking the example of writing the modified 20-2′ back to the cache region (where the first data point is 20-2), the center point data is 16-3 at this time. The second row number difference between the row number of the center point data and the first data point is 4, and the first cache row number of the center point data in the cache is 5, the second cache row number determined based on the first cache row number and the second row number difference is 9. Since the second cache row number (9) is less than the maximum cache row number (10), the modified 20-2′ is directly written back to the cache location corresponding to the second cache row number and the target column number (i.e., the cache position at line buffer 9, column 3). As another example, when writing the 21-3′ modified from 21-3 back to the cache (where the first data point is 21-3), the row number difference between the row numbers of the center point data and the first point data is 5, and the first cache row number is 5, and the second cache row number determined based on the first cache row number and the second row number difference is 10. Since the second cache row number (10) equals the maximum cache line number, 21-3′ is directly written back to the cache location corresponding to the second cache row number and the target column number (i.e., the cache position at line buffer 10, column 4). It should be noted that for cached data 9-4 in historical sliding window data 701, when updated to cached data 20-4 in historical sliding window data 702, the cached data at its cache location has already been updated to 20-4. Therefore, for cached data, such as 12-2, 11-3, 11-4, 16-2, 16-4, 20-4, not modified during i-th level algorithm processing, no write-back to the cache region is needed.

Conversely, if the determined second cache row number is greater than the maximum cache row number, no corresponding cache location exists in the cache region. The cache row number after circular wrapping needs to be determined. Based on the third row number difference between the second cache row number and the cache row count M of the cache region, a third cache row number is determined, and the first cached data is stored in the cache location corresponding to the third cache row number and target column number.

Exemplarily, if cache region row count M is 11, cache row numbers are 0-10, the maximum cache row number is 10, and the determined second cache row number is 12, which is greater than the maximum cache row number.

At this point, based on the difference between the second cache row number (12) and the cache region row count (11), the third row number difference is determined to be 1. The third cache row number is consequently determined as 1, and the first cached data is then written back to the cache location with cache row number being 1.

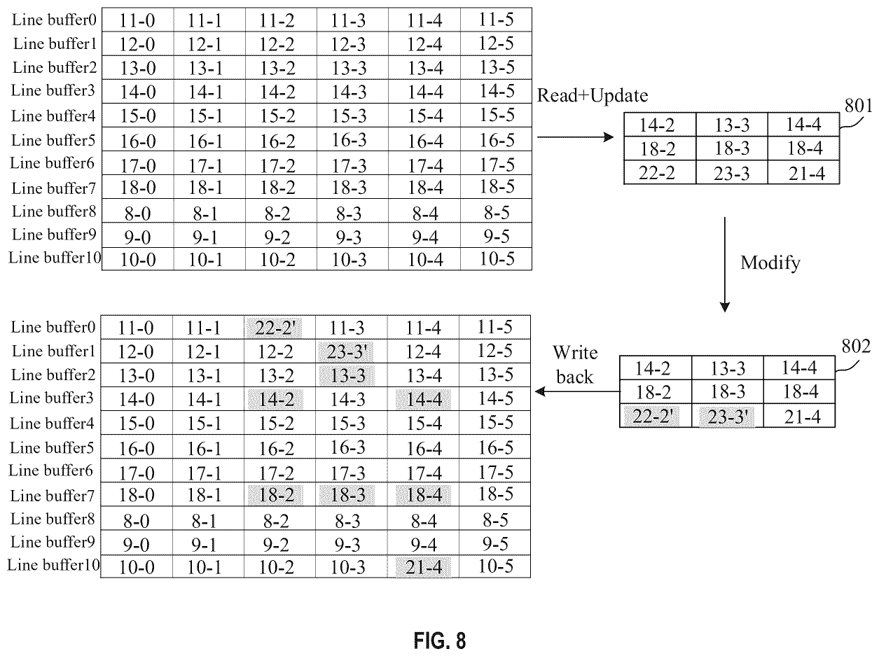

FIG. 8 is a schematic diagram of another process for writing back cached data according to an embodiment of this application. If historical sliding window data was acquired with 18-3 as the center point data, this historical sliding window data 801 used sliding window data (14-2, 13-3, 14-4, 18-2, 18-4, 22-2, 23-3, 21-4) during computation. During processing, cached data for 22-2 and 23-3 were modified (e.g., 22-2′ and 23-3′ in modified historical sliding window data 802). During the process of writing back the modified data to the cache region after computation, taking the modification of 22-2 that needs to be written back to the cache region as an example (i.e., the first point data is 22-2): the center point data at this time is 18-3, the second row number difference between the row numbers of the center point data and the first point data is 4; the first cache row number of the center point data in the cache region is 7, and the second cache row number is determined to be 11, based on the first cache row number and the second row number difference. Since the second cache row number is greater than the maximum cache row number of 10, the third row number difference between the second cache row number 11 and the cache row count 11 of the cache region is determined to be 0, meaning the third cache row number is 0. The modified 22-2′ is then written back to the cache location corresponding to the third cache row number and the target column number in the cache region (i.e., the cache location at line buffer 0 row, second column). For another example, taking the modification of 23-3 and writing the modified 23-3′ back to the cache region (i.e., the first data point is 23-3), the row number difference between the row numbers of the center point data and the first data point is 5, the first cache row number is 7, the second cache row number is determined to be 12, based on the first cache row number and the second row number difference. Since the second cache row number is greater than the maximum cache row number of 10, the third row number difference between the second cache row number 12 and the cache row count 11 of the cache region is determined to be 1, meaning the third cache row number is 1. The modified 23-3′ is then written back to the cache location corresponding to the third cache row number and the target column number in the cache region (i.e., the cache location at line buffer 1 row, third column).

Step 605: When processing current point data by the i-th level algorithm, reading current sliding window data centered on the current point data.

In this embodiment, when processing current point data with the i-th level algorithm, the current sliding window data is read centered on the current point data. This current sliding window data includes the first cached data that was modified and written back during the processing of the historical sliding window data.

Step 606: Acquiring a first row number corresponding to the current point data.

Considering that during the processing of historical sliding window data, the modified data written back uses the row number information of the center point data as the tag information, when processing the current point data, if the cached data read in the current sliding window data was written back using this tagging method, meaning the tag information is not the row number information of the point data itself, it is impossible to judge by comparing whether the row number of the point data required for the current sliding window data matches the tag information in the cached data. In this case, the target point data is determined by judging the relationship between a target threshold and the row number difference between the row number of the current point data and the tag information. That is, when writing back the modified point data based on the row number information of the center point data as the marked information, during the subsequent sliding window processing, Judgment Method 1 is adopted: determining whether the point data in the cached data is the target point data based on the row number information of the center point data and the tag information in the cached data.

Considering that for any point, the difference of row coordinates before and after sorting does not exceed a preset number of rows, the row number difference between the center point data's row number information and the tag information of the cached data also does not exceed this preset number of rows. When judging whether the point data in the cached data is the target point data, the row number information corresponding to the current point data, i.e., the first row number, is first acquired to facilitate subsequent judgment based on the first row number and the tag information.

Step 607: Determining a first row number difference between the first row number and the row number indicated by the tag information.

Acquire the first row number difference between the first row number and the row number indicated by the tag information in the read cached data, to judge whether the point data in the cached data is the target point data based on the magnitude of this first row number difference.

Step 608: If the first row number difference is greater than the target threshold, determining that the point data in the cached data is not the target point data.

The target threshold is set to the preset number of rows. For example, if the row difference before and after sorting for any point does not exceed 5 rows, the target threshold can be 5.

The LiDAR uses a MEMS galvanometer as the scanning device. After scanning the field of view, point cloud data is obtained. One detection period yields one frame of point cloud data. One frame of point cloud data includes multiple point data. During the detection period, the scanning device of the LiDAR performs reciprocating motion around a first axis and a second axis respectively. One detection period includes P first scanning cycles corresponding to the first axis and Q second scanning cycles corresponding to the second axis, where P and Q are positive integers. The target threshold equals the number of rows of point cloud data obtained by other second scanning cycles existing between two rows of point cloud data obtained by one second scanning cycle.

By comparing the first row number difference (described above) between the row number information of the center point data (i.e., the current point data) and the row number indicated by the tag information in the cached data, with the size relationship to the target threshold, it is determined whether the point data in the cached data is the target point data.

Specifically, based on the first row number difference described above, when the first row number difference is greater than the target threshold, it indicates that the row number information in the read cached data does not satisfy the preset row number relationship with the center point data's row number information. Therefore, it is determined that the point data in the cached data is not the target point data.

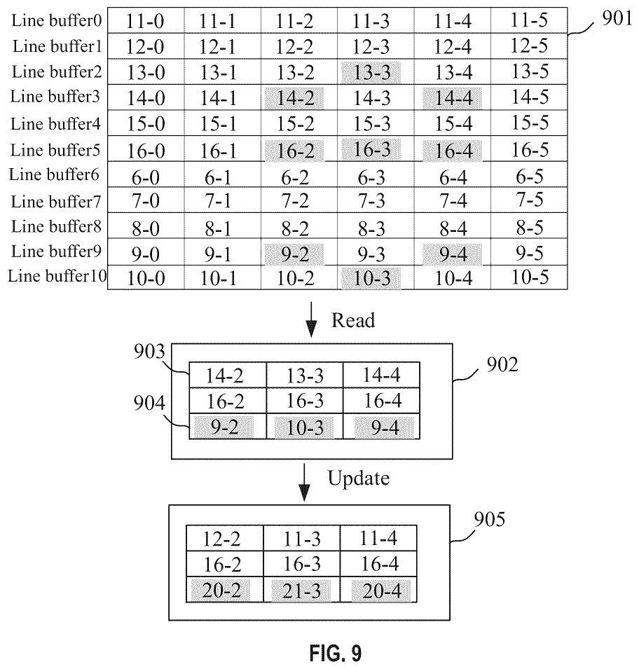

FIG. 9 is a schematic diagram of a target point data determination process according to an embodiment of this application. As shown in FIG. 9, taking a target threshold of 5 as an example, the current sliding window data 902 read from cache region 901 based on current point data 16-3 includes 14-2, 13-3, 14-4, 16-2, 16-4, 9-2, 10-3, and 9-4. The first row number of the center point data is 16. For position 1 (904), the row number indicated by the tag information in cached data 1 is 9. The first row number difference between cached data 1 and the center point data is 7. Since the first row number difference is greater than the target threshold, it can be determined that the point data in cached data 1 is not the target point data.

Step 609: If the first row number difference is less than or equal to the target threshold, determining that the point data in the cached data is the target point data.

When the first row number difference is less than or equal to the target threshold, it indicates that the row number information in the read cached data satisfies the preset relationship with the row number information of the center point data. Thus, it can be determined that the point data in the cached data is the target point data.

Exemplarily, continuing with the example shown in FIG. 9, the target threshold is 5. Based on the current point data 16-3, the current sliding window data read from cache region 901 is shown as 902, including 14-2, 13-3, 14-4, 16-2, 16-4, 9-2, 10-3, and 9-4. The first row number of the center point data is 16. For position 2 (903), the row number indicated by the tag information in the cached data 2 is 14. The first row number difference between cached data 2 and the center point data is 2. Since this first row number difference is less than the target threshold, it can be determined that the point data in cached data 2 is the target point data.

Step 610: If the point data in the cached data is the target point data, determining this point data as the target point data.

Step 611: If the point data in the cached data is not the target point data, reading the target point data from point cloud data processed by the (i−1)-th level algorithm.

Step 612: Determining corresponding cached data based on the target point data.

Step 613: Updating the current sliding window data based on the determined cached data, and performing the i-th level algorithm processing on the current sliding window data.

As shown in FIG. 9, taking the read current sliding window data 902 as an example. Since the row number difference between the row number indicated by the tag information in the cached data read at unfilled positions (e.g., position 903) and the row number of the center point data is less than the target threshold, the cached data at this position is not updated. Since the row number difference between the row number indicated by the tag information in the cached data read at gray-filled positions (e.g., position 904) and the row number of the center point data is greater than the target threshold, the required target point data for this position needs to be read from the (i−1)-th level algorithm module, and the cached data at this position is updated. The updated current sliding window data is finally obtained as shown in 905.

Implementation of Steps 610-613 can be referred to Steps 503-506. Details are not repeated here.

In this embodiment, when performing i-th level algorithm processing on historical sliding window data, if the first cached data in the historical sliding window data is modified, the center point data's row number is used as tag information when writing back the modified point data to the cache region. During subsequent sliding window processing, the row number information of the center point data is compared with the tag information to determine whether the cached data is the target point data. This ensures that even with multiple modifications, specific judgment methods can still determine whether the read cached data is the point data required for current sliding window processing, improving the accuracy of sliding window data processing.

The previous embodiment described the process of how to write back modified data and subsequently determine whether the read cached data is the point data required for current sliding window processing when using the row number of the sliding window's center point to mark the modified point data being written back. This embodiment mainly describes the write-back and judgment process when using the row number of the modified point as the tag information.

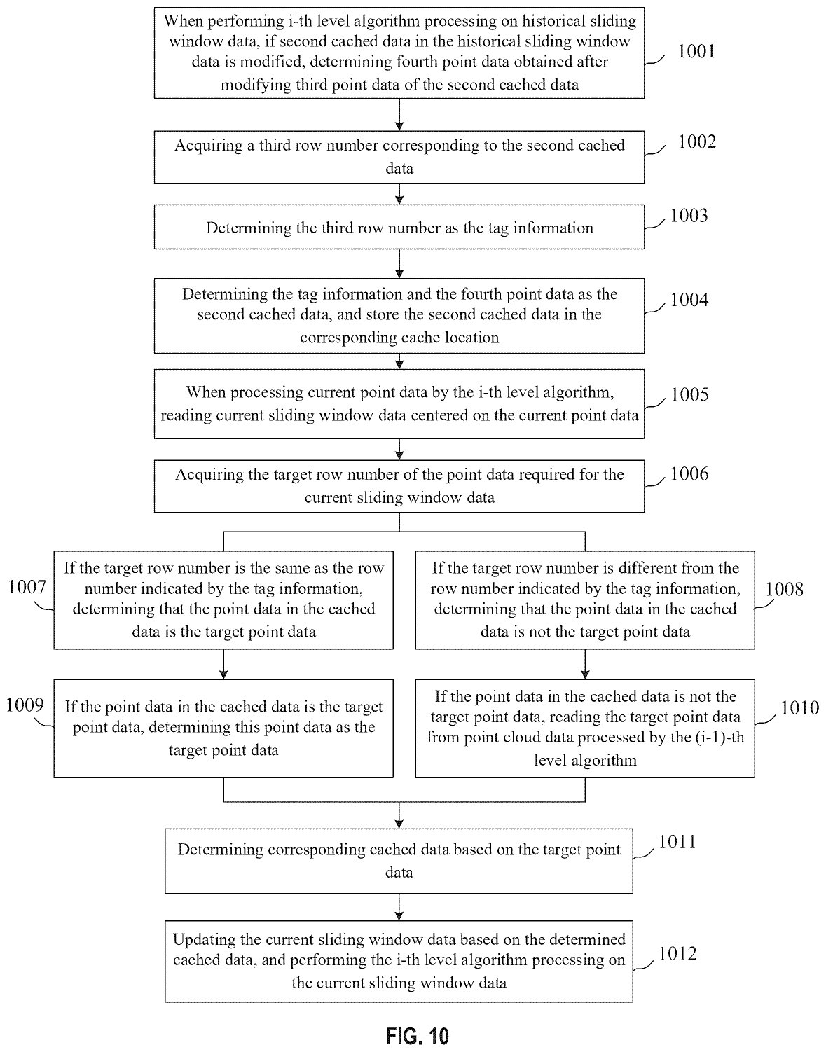

FIG. 10 is a schematic flowchart of another point cloud data processing method according to an embodiment of this application. Exemplarily, as shown in FIG. 10, method 1000 includes:

Step 1001: When performing i-th level algorithm processing on historical sliding window data, if second cached data in the historical sliding window data is modified, determining fourth point data obtained after modifying third point data of the second cached data.

When performing i-th level algorithm processing on historical sliding window data, if the second cached data in the historical sliding window data is modified, the modified point data needs to be written back to the corresponding cache location in the cache region so that the modified point data can be used in subsequent sliding window processing. Considering that each cache location stores cached data composed of point data and tag information, when caching the modified point data to the cache location, both the point data to be cached and its tag information need to be obtained. In one implementation, when performing i-th level algorithm processing on historical sliding window data, if the second cached data in the historical sliding window data is modified, first determine the fourth point data obtained after modifying the third point data of the second cached data, and then determine the tag information used to mark the row number corresponding to the fourth point data.

Step 1002: Acquiring a third row number corresponding to the second cached data.

Step 1003: Determining the third row number as the tag information.

Two primary methods are provided for determining the tag information identifying the row number corresponding to the modified fourth point data:
Method 1: Use the row number of the sliding window's center point to mark the modified point data being written back.
Method 2: Use the row number of the modified point to mark the modified point data being written back.

If Method 2 is used to mark the modified point data being written back, for the historical sliding window data, it is necessary to acquire the third row number of the second cached data modified in the historical sliding window data (i.e., the row number information corresponding to the third point data in the second cached data), so as to determine the third row number as the tag information marking the point data modified during i-th level algorithm processing.

Step 1004: Determining the tag information and the fourth point data as the second cached data, and store the second cached data in the corresponding cache location.

Correspondingly, the tag information (third row number) and the fourth point data are concatenated to form the second cached data, which is then stored in the corresponding cache location.

It should be noted that the method for storing the second cached data in the corresponding cache location can refer to the method for storing the first cached data in the corresponding cache location in the previous embodiment, and details are not repeated here. That is, storing the second cached data in the corresponding cache location may further include Steps 1004A to 1004C.

Step 1004A: Acquiring a first cache row number of the center point data of the historical sliding window data in the cache region, a target column number of the third point data, and a fourth row number difference between the row number of the third point data and the row number of the center point data.

Step 1004B: Based on the first cache row number and the fourth row number difference, determining a fourth cache row number of the cache location for the third point data in the cache region.

Step 1004C: Based on the relationship between the fourth cache row number and the maximum cache row number of the cache region, storing the second cached data in the corresponding cache location.

Specifically, if the fourth cache row number is less than or equal to the maximum cache row number of the cache region, store the second cached data in the cache location corresponding to the fourth cache row number and the target column number. If the fourth cache row number is greater than the maximum cache row number of the cache region, determine a fifth cache row number based on a fifth row number difference between the fourth cache row number and the cache row count; then store the second cached data in the cache location corresponding to the fifth cache row number and the target column number.

Step 1005: When processing current point data by the i-th level algorithm, reading current sliding window data centered on the current point data.

In this embodiment, when processing current point data with the i-th level algorithm, the current sliding window data is read centered on the current point data. This current sliding window data includes the second cached data that was modified and written back during the processing of the historical sliding window data.

Step 1006: Acquiring the target row number of the point data required for the current sliding window data.

Considering that during the processing of historical sliding window data, the modified data written back uses the row number of the modified point data as the tag information, when processing the current point data, if the cached data read in the current sliding window data was written back using this tagging method, meaning that the tag information is the row number information of the point data, the judgement method based on the row number information of the point data required for the current the current sliding window data and the tag information in the cached data. That is, in the scenario where the modified point data written back is marked with the row number information of the modified point, during subsequent sliding window processing, Judgment Method 2 is used: judging whether it is the target point data based on the row number information of any required cached data in the current sliding window data and the tag information in the read cached data.

When reading the current sliding window data centered on the current point data, first determine each point data in the current sliding window data based on the sorted point cloud data. Then determine the target row number corresponding to the cached data required at each position in the original point cloud data based on the spatial index mapping table of pre-sorting and post-sorting point cloud positions. Further, determine whether the point data in the read cached data is the required target point data by judging whether the target row number matches the row number indicated by the tag information in the cached data read at that position.

Step 1007: If the target row number is the same as the row number indicated by the tag information, determining that the point data in the cached data is the target point data.

For any position in the current sliding window data, if the row number of the point data in the cached data read at that position is consistent with the target row number of the point data actually required at the same position, it indicates that the point data in the cached data at that position is valid data; otherwise, it is data that needs to be discarded.

When judging whether it is the target point data, if it is determined that the target row number is the same as the row number indicated by the read tag information, it can be confirmed that the read cached data is correct, and the cached data is the target point data required for processing the current point data.

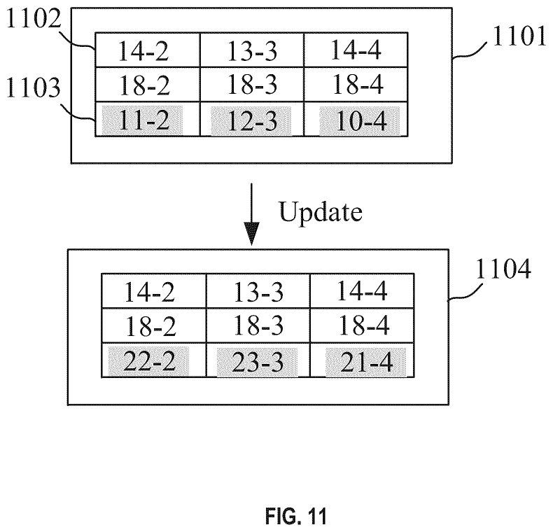

FIG. 11 is a schematic diagram of another target point data determination process according to an embodiment of this application. As shown in FIG. 11, based on current point data 18-3, the read current sliding window data 1101 is shown. For position 1 (1102), the target row number required for position 1 is 14, and the row number indicated by the tag information in cached data 1 read at position 1 is 14. The two are consistent, so it is determined that point data 1 in cached data 1 is the target point data required for processing the current point data.

Step 1008: If the target row number is different from the row number indicated by the tag information, determining that the point data in the cached data is not the target point data.

Conversely, if it is determined that the target row number is different from the row number indicated by the tag information, it can be confirmed that the read cached data is not the target point data required for processing the current point data.

Exemplarily, as shown in FIG. 11, for position 2 (1103), the target row number required for position 2 is 22, and the row number indicated by the tag information in cached data 2 read at position 2 is 11. The two are inconsistent. Therefore, the point data in cached data 2 at position 2 is determined not to be the target point data.

Step 1009: If the point data in the cached data is the target point data, determining this point data as the target point data.

Step 1010: If the point data in the cached data is not the target point data, reading the target point data from point cloud data processed by the (i−1)-th level algorithm.

Step 1011: Determining corresponding cached data based on the target point data.

Step 1012: Updating the current sliding window data based on the determined cached data, and performing the i-th level algorithm processing on the current sliding window data.

As shown in FIG. 11, taking the read current sliding window data 1101 as an example. Since the row number indicated by the tag information in the cached data read at unfilled positions (e.g., position 1102) matches the required target row number, the cached data at this position is not updated. Since the row number indicated by the tag information in the cached data read at gray-filled positions (e.g., position 1103) does not match the required target row number, the required target point data for this position must be read from the (i−1)-th level algorithm, and the cached data at this position is updated. The updated current sliding window data is finally obtained as shown in 1104.

Implementation of Steps 1009-1012 can be referred to Steps 503-506. Details are not repeated here.

In this embodiment, when performing i-th level algorithm processing on historical sliding window data, if the second cached data in the historical sliding window data is modified, the row number information of the modified point data is used as tag information when writing back the modified point data to the cache region. During subsequent sliding window processing, whether the cached data is the target point data is determined by comparing the row number information of the point data required for the current sliding window data with the tag information. This ensures that even with multiple modifications, specific judgment methods can still determine whether the read cached data is the point data required for current sliding window processing, improving the accuracy of sliding window data processing.

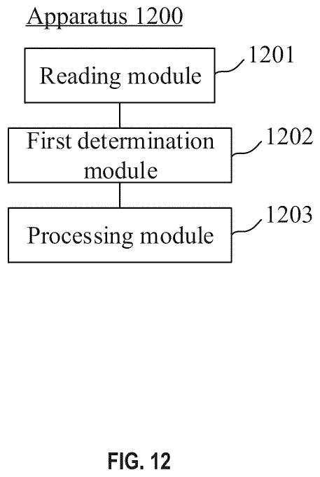

FIG. 12 is a structural schematic diagram of a point cloud data processing apparatus according to an embodiment of this application. Exemplarily, as shown in FIG. 12, the apparatus 1200 includes:

Reading module 1201, configured to read current sliding window data centered on current point data when processing the current point data by an i-th level algorithm. The current sliding window data includes at least two cached data. Each cached data is stored in a corresponding cache location. Each cached data includes point data and tag information identifying row number information of the point data. i is an integer greater than 1.

First determination module 1202, configured to determine target point data based on the tag information, and determine corresponding cached data based on the target point data.

Processing module 1203, configured to update the current sliding window data based on the determined cached data, and perform the i-th level algorithm processing on the current sliding window data.

In some embodiments, the first determination module 1202 is further configured to:
determine whether the point data in the cached data is the target point data required for processing the current point data based on the tag information;
if the point data in the cached data is the target point data, determine the point data in the cached data as the target point data; and
if the point data in the cached data is not the target point data, read the target point data from point cloud data processed by an (i−1)-th level algorithm.

In some embodiments, the first determination module 1202 is further configured to:
acquire a first row number corresponding to the current point data;
determine a first row number difference between the first row number and a row number indicated by the tag information;
if the first row number difference is greater than a target threshold, determine that the point data in the cached data is not the target point data; and
if the first row number difference is less than or equal to the target threshold, determine that the point data in the cached data is the target point data.

In some embodiments, the apparatus further includes:

Second determination module, configured to, when performing i-th level algorithm processing on historical sliding window data, if first cached data in the historical sliding window data is modified, determine second point data obtained after modifying first point data of the first cached data.

First acquisition module, configured to acquire a second row number of center point data of the historical sliding window data.

Third determination module, configured to determine the second row number as the tag information.

First caching module, configured to determine the tag information and the second point data as the first cached data, and store the first cached data in the corresponding cache location.

In some embodiments, the first determination module 1202 is further configured to: acquire a target row number of point data required in the current sliding window data; if the target row number is the same as a row number indicated by the tag information, determine that the point data in the cached data is the target point data; and if the target row number is different from the row number indicated by the tag information, determine that the point data in the cached data is not the target point data.

In some embodiments, the apparatus further includes:

Fourth determination module, configured to, when performing i-th level algorithm processing on historical sliding window data, if second cached data in the historical sliding window data is modified, determine fourth point data obtained after modifying third point data of the second cached data.

Second acquisition module, configured to acquire a third row number corresponding to the second cached data.

Fifth determination module, configured to determine the third row number as the tag information.

Second caching module: configured to determine the tag information and the fourth point data as the second cached data, and store the second cached data in the corresponding cache location.

In some embodiments, the point cloud data is obtained after a LiDAR scans a field of view. One detection period yields one frame of the point cloud data. One frame of the point cloud data comprises multiple point data. During the detection period, a scanning device of the LiDAR performs reciprocating motion around a first axis and a second axis, respectively. The detection period comprises P first scanning cycles corresponding to the first axis and Q second scanning cycles corresponding to the second axis, P and Q are positive integers.

The target threshold equals the number of rows of point cloud data obtained by other second scanning cycles existing between two rows of point cloud data obtained by one second scanning cycle.

In some embodiments, the cache region corresponding to the algorithm comprises multiple cache locations. A cache row count of the cache region is less than a row count of one frame of point cloud data. The cache row count of the cache region is greater than twice the target threshold.

The first caching module is further configured to:
acquire a first cache row number of center point data of the historical sliding window data in the cache region, a target column number of the first point data, and a second row number difference between a row number of the first point data and a row number of the center point data;
determine a second cache row number of the first point data in the cache region based on the first cache row number and the second row number difference; and
store the first cached data in the corresponding cache location based on a relationship between the second cache row number and a maximum cache row number of the cache region.

In some embodiments, the first caching module is further configured to:
if the second cache row number is less than or equal to the maximum cache row number of the cache region, store the first cached data in a cache location corresponding to the second cache row number and the target column number; and
if the second cache row number is greater than the maximum cache row number of the cache region, determine a third cache row number based on a third row number difference between the second cache row number and the cache row count; and store the first cached data in a cache location corresponding to the third cache row number and the target column number.

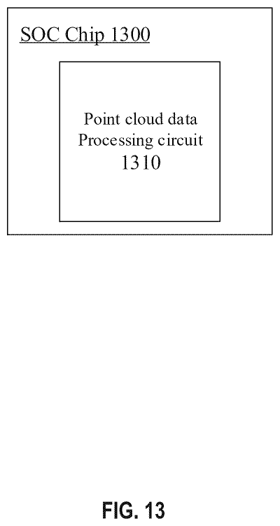

FIG. 13 is a structural schematic diagram of an SoC chip according to an embodiment of this application.

Exemplarily, as shown in FIG. 13, the SoC chip 1300 is configured with a point cloud data processing circuit 1310. The point cloud data processing circuit 1310 can execute the point cloud data processing method shown in the foregoing embodiments during use.

Embodiments of this application further provide a computer-readable storage medium. The computer-readable storage medium stores computer program code. When the computer program code is run on a LiDAR, it causes the LiDAR to execute the related method steps to implement the point cloud data processing method in the foregoing embodiments.

This embodiment further provides a computer program product. When the computer program product is run on a LiDAR, it causes the LiDAR to execute the related steps to implement the point cloud data processing method in the foregoing embodiments.

Through the description of the above implementations, those skilled in the art can understand that for the convenience and conciseness of description, only the division of the above functional modules is used as an example. In practical applications, the above functions can be allocated to different functional modules according to needs, that is, the internal structure of the device is divided into different functional modules to complete all or part of the functions described above.

In the embodiments provided in this application, it should be understood that the disclosed apparatus and method may be implemented in other ways. For example, the apparatus embodiments described above are merely illustrative. For example, the division of modules or units is only a logical function division. In actual implementation, there may be other division methods. For example, multiple units or components may be combined or integrated into another device, or some features may be ignored or not implemented. In addition, the displayed or discussed mutual coupling or direct coupling or communication connection may be indirect coupling or communication connection through some interfaces, devices, or units, and may be in electrical, mechanical, or other forms.

The above content is only exemplary implementations of this application, but the protection scope of this application is not limited thereto. Any person skilled in the art can easily conceive of changes or substitutions within the technical scope disclosed in this application, which should be covered within the protection scope of this application. Therefore, the protection scope of this application shall be defined by the scope of the claims.

What is claimed is:

1. A method for point cloud data processing, comprising:
when processing current point data by an i-th level algorithm, reading current sliding window data centered on the current point data, the current sliding window data including at least two cached data, each cached data being stored in a corresponding cache location, each cached data comprising point data and tag information identifying row number information of the point data, wherein i is an integer greater than 1;
determining target point data based on the tag information, and determining corresponding cached data based on the target point data; and
updating the current sliding window data based on the cached data that has been determined, and performing the i-th level algorithm processing on the current sliding window data.

2. The method according to claim 1, wherein determining the target point data based on the tag information comprises:
determining whether the point data in the cached data is the target point data required for processing the current point data, based on the tag information;
when the point data in the cached data is the target point data, determining the point data in the cached data as the target point data; and
when the point data in the cached data is not the target point data, reading the target point data from point cloud data processed by an (i−1)-th level algorithm.

3. The method according to claim 2, wherein determining whether the point data in the cached data is the target point data required for processing the current point data, based on the tag information comprises:
acquiring a first row number corresponding to the current point data;
determining a first row number difference between the first row number and a row number indicated by the tag information;
when the first row number difference is greater than a target threshold, determining that the point data in the cached data is not the target point data; and
when the first row number difference is less than or equal to the target threshold, determining that the point data in the cached data is the target point data.

4. The method according to claim 3, wherein:
before reading the current sliding window data centered on the current point data, the method comprises:
when performing the i-th level algorithm processing on historical sliding window data, when a first cached data in the historical sliding window data is modified, determining a second point data obtained after modifying a first point data of the first cached data;
acquiring a second row number of center point data of the historical sliding window data;
determining the second row number as the tag information; and
determining the tag information and the second point data as the first cached data, and storing the first cached data in the corresponding cache location.

5. The method according to claim 2, wherein determining whether the point data in the cached data is the target point data required for processing the current point data, based on the tag information comprises:
acquiring a target row number of point data required in the current sliding window data;
when the target row number is the same as a row number indicated by the tag information, determining that the point data in the cached data is the target point data; and
when the target row number is different from the row number indicated by the tag information, determining that the point data in the cached data is not the target point data.

6. The method according to claim 5, wherein:
before reading the current sliding window data centered on the current point data, the method comprises:
when performing the i-th level algorithm processing on historical sliding window data, when a second cached data in the historical sliding window data is modified, determining a fourth point data obtained after modifying a third point data of the second cached data;
acquiring a third row number corresponding to the second cached data;
determining the third row number as the tag information; and
determining the tag information and the fourth point data as the second cached data, and storing the second cached data in the corresponding cache location.

7. The method according to claim 3, wherein the point cloud data is obtained after a LiDAR scans a field of view, one detection period yields one frame of the point cloud data, one frame of the point cloud data comprises multiple point data, during the detection period, a scanning device of the LiDAR performs reciprocating motion around a first axis and a second axis respectively, the detection period comprises P first scanning cycles corresponding to the first axis and Q second scanning cycles corresponding to the second axis, P and Q being positive integers,
wherein the target threshold equals a number of rows of point cloud data obtained by other second scanning cycles existing between two rows of point cloud data obtained by one second scanning cycle.

8. The method according to claim 4, wherein a cache region corresponding to the algorithm comprises multiple cache locations, a cache row count of the cache region is less than a row count of one frame of point cloud data, and the cache row count of the cache region is greater than twice the target threshold,
wherein storing the first cached data in the corresponding cache location comprises:
acquiring a first cache row number of center point data of the historical sliding window data in the cache region, a target column number of the first point data, and a second row number difference between a row number of the first point data and a row number of the center point data;
determining a second cache row number of the first point data in the cache region based on the first cache row number and the second row number difference; and
storing the first cached data in the corresponding cache location based on a relationship between the second cache row number and a maximum cache row number of the cache region.

9. The method according to claim 8, wherein storing the first cached data in the corresponding cache location based on the relationship between the second cache row number and the maximum cache row number of the cache region comprises:
when the second cache row number is less than or equal to the maximum cache row number of the cache region, storing the first cached data in a cache location corresponding to the second cache row number and the target column number; and
when the second cache row number is greater than the maximum cache row number of the cache region, determining a third cache row number based on a third row number difference between the second cache row number and the cache row count, and storing the first cached data in a cache location corresponding to the third cache row number and the target column number.

10. A point cloud data processing apparatus, comprising:
a reading module, configured to read current sliding window data centered on current point data when processing the current point data by an i-th level algorithm, the current sliding window data including at least two cached data, each cached data being stored in a corresponding cache location, each cached data comprising point data and tag information identifying row number information of the point data; wherein i is an integer greater than 1;
a first determination module, configured to determine target point data based on the tag information, and determine corresponding cached data based on the target point data; and
a processing module, configured to update the current sliding window data based on the cached data which has been determined, and perform the i-th level algorithm processing on the current sliding window data.

11. A point cloud data processing circuit, configured to execute the point cloud data processing method according to claim 1.
